(19) United States
(12) Patent Application Publication
(10) Pub. No.: US 2019/0024587 A1
(43) Pub. Date: Jan. 24, 2019

(54) FAN INTEGRATED INERTIAL PARTICLE SEPARATOR

(71) Applicant: Rolls-Royce North American Technologies, Inc., Indianapolis, IN (US)

(72) Inventors: Crawford F. Smith, III, Carmel, IN (US); Victor Oechsle, Avon, IN (US); Bryan H. Lerg, Carmel, IN (US); William B. Bryan, Indianapolis, IN (US)

(21) Appl. No.: 15/652,432

(22) Filed: Jul. 18, 2017

(51) Int. Cl. F02C 7/052; F02C 3/04; F02C 9/18; F02K 3/06; F02C 7/057

(52) U.S. Cl. CPC F02C 7/052; F02C 3/04; F02C 9/18; F05D 2240/12; F02C 7/057; F05D 2220/32; F02K 3/06

(57) ABSTRACT

A gas turbine engine includes a fan, an engine core, and an airflow duct assembly. The fan is mounted for rotation about a central axis of the gas turbine engine assembly to produce thrust for the gas turbine engine. The engine core is coupled to the fan and configured to drive the fan about the central axis. The airflow duct assembly defines a core passageway configured to conduct a first portion of air pushed by the fan into the engine core and a by-pass passageway configured to conduct a second portion air pushed by the fan around the engine core.

### STATEMENT REGARDING FEDERALLY SPONSORED RESEARCH OR DEVELOPMENT

Embodiments of the present disclosure were made with government support under Contract No. W911W6-16-2-0011. The government may have certain rights.

### FIELD OF THE DISCLOSURE

The present disclosure relates generally to gas turbine engines, and more specifically to particle separators included in gas turbine engines.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high pressure air and is ignited. Products of the combustion reaction in the combustor are directed into the turbine where work is extracted to drive the compressor and, sometimes, an output shaft. Left-over products of the combustion are exhausted out of the turbine and may provide thrust in some applications.

Air is drawn into the engine and communicated to the compressor via a core passageway. In some operating conditions, particles may be entrained in the air such as dust, sand, or liquid water and may be drawn into the engine and passed through the core passageway to the compressor. Such particles may impact components of the compressor and turbine causing damage and wear. This damage and wear may decrease power output of the engine, shorten the life span of the engine, and lead to increased maintenance costs and down time of the engine.

### SUMMARY

The present disclosure may comprise one or more of the following features and combinations thereof.

A gas turbine engine in accordance with the present disclosure may include a fan, an engine core, and an airflow duct assembly. The fan may be mounted for rotation about a central axis of the gas turbine engine. The engine core may be coupled to the fan and configured to drive the fan about the central axis to cause the fan to push a mixture of air and particles suspended in the air to provide thrust for the gas turbine engine. The airflow duct assembly may be configured to conduct the mixture of air and particles through the gas turbine engine.

In some embodiments, the airflow duct assembly may define a core passageway configured to conduct a first portion of the mixture of air and particles pushed by the fan into the engine core and a by-pass passageway configured to conduct a second portion of the mixture of air and particles pushed by the fan around the engine core. The airflow duct assembly may include a particle-separator splitter positioned in the core passageway and configured to separate the first portion of the mixture of air and particles into a clean flow substantially free of particles and a dirty flow containing the particles and the particle-separator splitter is arranged to direct the clean flow into the engine core and the dirty flow away from the engine core.

In some embodiments, the airflow duct assembly may further include an inner wall arranged circumferentially around the central axis, an outer wall arranged circumferentially around the inner wall and the fan, and a by-pass flow splitter located radially between the inner wall and the outer wall. The inner wall and the by-pass flow splitter may define the core passageway. The outer wall and the by-pass flow splitter may define the by-pass passageway. A tip of the particle-separator splitter may be located downstream of a tip of the by-pass flow splitter.

In some embodiments, the inner wall of the airflow duct assembly may include a forward portion and an aft portion located axially aft of the forward portion. The forward portion may form a radially outward extending peak having a maximum radius, the aft portion is located radially inward of the maximum radius of the peak of the forward portion, and the particle-separator splitter is located radially inward of the maximum radius of the peak of the forward portion.

In some embodiments, the particle-separator splitter and the by-pass flow splitter may define a scavenge passageway having an inlet that opens into the core passageway and an outlet that opens into the by-pass passageway. One of the inner wall and the outer wall may include a protrusion that extends radially into the by-pass passageway to reduce an area of the by-pass passageway. The protrusion may be located adjacent the outlet of the scavenge passageway.

In some embodiments, the airflow duct assembly may include a vane that extends between the by-pass flow splitter and the outer wall. The vane may be located adjacent the outlet of the scavenge passageway.

In some embodiments, the airflow duct assembly may further include a by-pass flow splitter configured to separate radially the by-pass passageway and the core passageway. The particle-separator splitter and the by-pass flow splitter may define a scavenge passageway in fluid communication with the core passageway and the by-pass passageway. The scavenge passageway may be arranged to conduct the dirty flow from the core passageway into the by-pass passageway.

In some embodiments, the gas turbine engine may further include a valve configured to move between an open position in which fluid flow through the scavenge passageway is allowed and a closed position in which fluid flow through the scavenge passageway is blocked. The airflow duct assembly may include an inner wall arranged circumferentially around the central axis, an outer wall arranged circumferentially around the inner wall and the fan, and a by-pass flow splitter located radially between the inner wall and the outer wall. The inner wall may include a forward portion and an aft portion located axially aft of the forward portion. The forward portion may extend radially outward away from the central axis and may cooperate with the central axis to define an angle alpha. The angle α (alpha) may be in a range of about 20 degrees to about 40 degrees.

According to another aspect of the present disclosure, a gas turbine engine may include a fan, an engine core, and an airflow duct assembly. The fan may be mounted for rotation about a central axis of the gas turbine engine. The engine core may be coupled to the fan and configured to drive the fan about the central axis to cause the fan to push a mixture of air and particles suspended in the air to provide thrust for the gas turbine engine. The airflow duct assembly may include an inner wall arranged circumferentially around the central axis, an outer wall arranged circumferentially around the inner wall and the fan, a by-pass flow splitter located radially between the inner wall and the outer wall to form a core passageway and a by-pass passageway arranged around the core passageway, and a particle-separator splitter positioned in the core passageway.

In some embodiments, the inner wall of the airflow duct assembly may include a forward portion and an aft portion located axially aft of the forward portion. The forward portion may form a radially outward extending peak having a maximum radius. The aft portion may be located radially inward of the maximum radius of the peak of the forward portion. The particle-separator splitter may be positioned radially inward of the maximum radius of the peak of the forward portion.

In some embodiments, the inner wall may include a forward portion and an aft portion located axially aft of the forward portion. The forward portion may extend radially outward away from the central axis and may cooperate with the central axis to define an angle alpha. The angle alpha may be in a range of about 20 degrees to about 40 degrees.

In some embodiments, the particle-separator splitter and the by-pass flow splitter may define a scavenge passageway in fluid communication with the core passageway and the by-pass passageway. The gas turbine engine may further include a valve configured to move between an open position in which fluid flow through the scavenge passageway is allowed and a closed position in which fluid flow through the scavenge passageway is blocked.

In some embodiments, a tip of the particle-separator splitter may be located downstream of a tip of the by-pass flow splitter. The particle-separator splitter and the by-pass flow splitter may define a scavenge passageway having an inlet that opens into the core passageway and an outlet that opens into the by-pass passageway. One of the inner wall and the outer wall may include a protrusion that extends radially into the by-pass passageway. The protrusion may be located adjacent and upstream of the outlet of the scavenge passageway.

In some embodiments, the particle-separator splitter and the by-pass flow splitter may define a scavenge passageway having an inlet that opens into the core passageway and an outlet that opens into the by-pass passageway. The airflow duct assembly may include a vane that extends between the by-pass flow splitter and the outer wall. The vane may be located adjacent and upstream of the outlet of the scavenge passageway.

According to another aspect of the present disclosure, a method may include a number of steps. The method may include providing a gas turbine engine having a fan, an engine core coupled to the fan, and a duct assembly arranged around the fan and the engine core, the duct assembly defining a core passageway in fluid communication with the engine core and a by-pass passageway arranged circumferentially around the core passageway. The method may further include directing a flow of air and particles suspended in the air downstream with the fan.

In some embodiments, the method may further include conducting a first portion of the flow of air and particles radially inward into the core passageway. In some embodiments, the method may further include conducting a second portion of the flow of air and particles into the by-pass passageway.

In some embodiments, the method may further include separating the first portion of the flow of air and particles into a dirty flow including substantially all the particles and a clean flow lacking substantially all the particles. The method may further include directing the dirty flow through a scavenge passageway into the by-pass passageway. The method may further include directing the clean flow to a compressor included in the engine core.

In some embodiments, the method may further include reducing a cross-sectional area of the by-pass passageway adjacent an outlet of the scavenge passageway. The duct assembly may further include a valve and the method further includes varying a flow rate through the scavenge passageway with the valve. The method may further include varying the flow rate with the valve based on operating conditions of the gas turbine engine and wherein the operating conditions include at least one of fan speed and an altitude of the gas turbine engine.

These and other features of the present disclosure will become more apparent from the following description of the illustrative embodiments.

### BRIEF DESCRIPTION OF THE DRAWINGS

FIG. 1 is a diagrammatic view of a gas turbine engine in accordance with the present disclosure showing that the gas turbine engine includes a fan, an engine core configured to drive the fan, and an airflow duct assembly configured to conduct a portion of the air pushed by the fan around the engine core;

FIG. 2 is an enlarged perspective and sectional view of the gas turbine engine of FIG. 1 showing that a particle separator is integrated into the airflow duct assembly and the particle separator is adapted to conduct air laden with particles around the engine core and to conduct clean air substantially without particles into the engine core;

FIG. 3 is a sectional view of the gas turbine engine shown in FIG. 2 suggesting that air laden with particles enters the gas turbine engine and the particle separator integrated into the airflow duct separates the air into a dirty flow with the particles and a clean flow without particles; and

FIG. 4 is an enlarged view of the gas turbine engine shown in FIG. 3.

### DETAILED DESCRIPTION OF THE DRAWINGS

For the purposes of promoting an understanding of the principles of the disclosure, reference will now be made to a number of illustrative embodiments illustrated in the drawings and specific language will be used to describe the same.

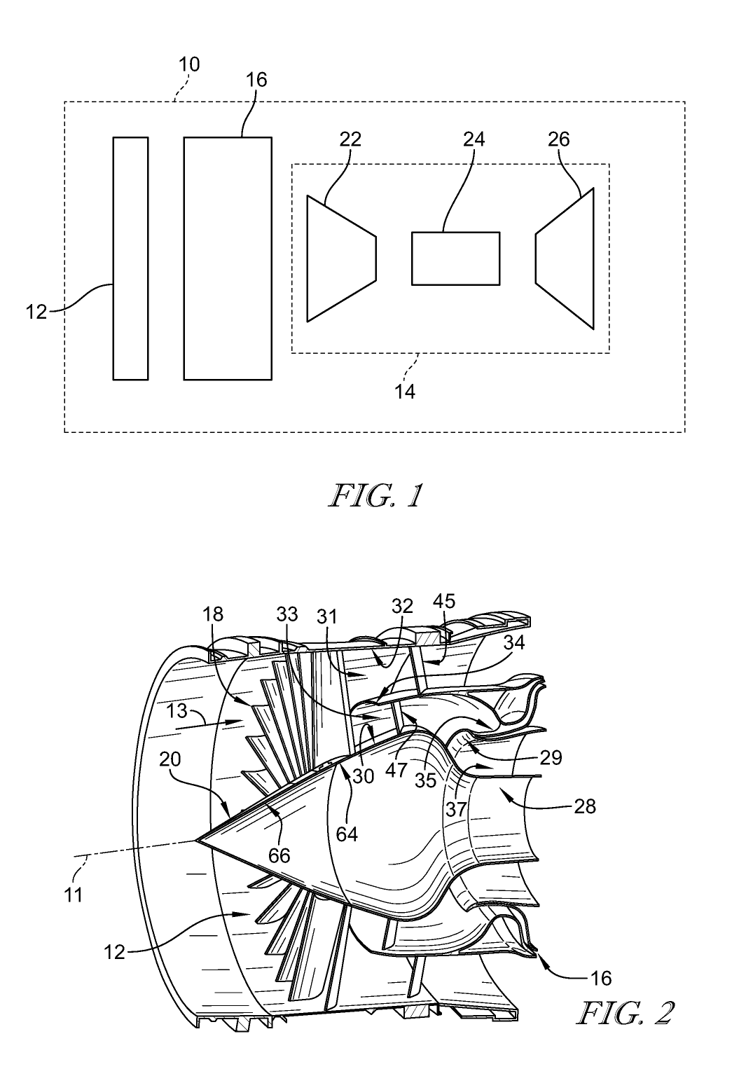

A gas turbine engine 10 in accordance with the present disclosure is shown diagrammatically in FIG. 1. The gas turbine engine 10 includes a fan 12, an engine core 14, and an airflow duct assembly 16. The fan 12 is mounted for rotation about a central axis 11 of the gas turbine engine 10 to push airflow 13 through the gas turbine engine 10 as suggested in FIG. 2. The engine core 14 is coupled to the fan 12 and is configured to drive the fan 12 about the central axis 11. The airflow duct assembly 16 is configured to conduct a first portion of the airflow 13 around the engine core 14 to produce thrust and to conduct a second portion of the airflow 13 into the engine core 14 for use in a combustion cycle.

The engine core 14 includes a compressor section 22, a combustor section 24, and a turbine section 26 as shown in FIG. 1. Air is directed into the gas turbine engine 10 through airflow duct assembly 16 and conducted into the compressor section 22 as suggested in FIG. 2. The compressor section 22 compresses the air and delivers high-pressure air to the combustor section 24. The combustor section 24 is configured to ignite a mixture of the compressed air and fuel. Products of the combustion process are directed into the turbine section 26 where work is extracted to drive the compressor section 22 and fan 12.

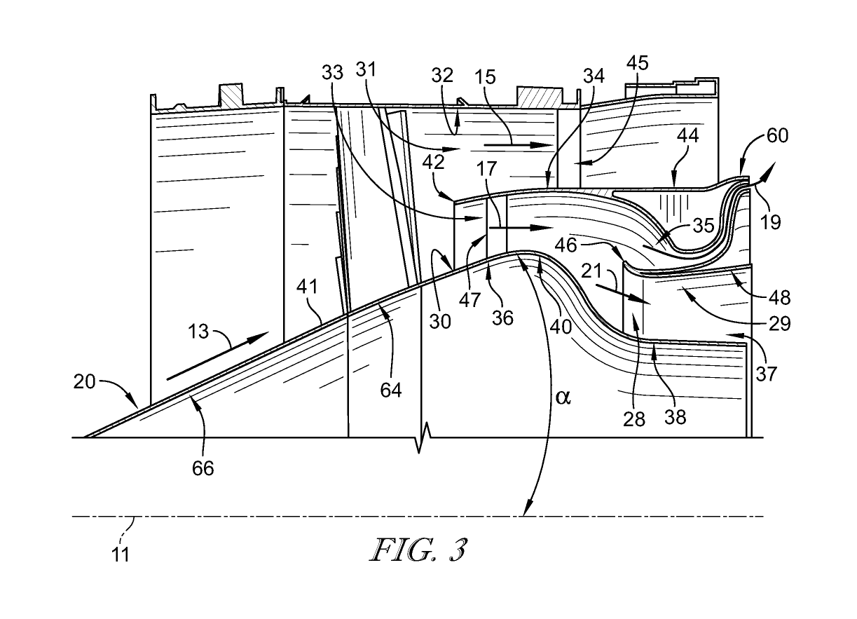

In some environments, particles such as dirt, sand, or liquid water may be entrained in airflow 13 and carried into the gas turbine engine 10. The illustrative airflow duct assembly 16 includes a particle separator 28 configured to separate the airflow 13 into a dirty airflow 19 having substantially all of the particles and a clean airflow 21 substantially without particles as suggested in FIG. 3. The clean airflow 21 is conducted into the compressor section 22 so that damage to the compressor section 22, combustor section 24, and turbine section 26 is minimized. The dirty airflow 19 is directed into a by-pass passageway 31 and around the engine core 14 to provide thrust.

The fan 12 includes a plurality of fan blades 18 and a hub 20 as shown in FIG. 2. The fan blades 18 are arranged circumferentially around the central axis 11. The hub 20 is shaped to direct at least a portion of the airflow 13 radially outward from the central axis 11 toward the airflow duct assembly 16. In the illustrative embodiment, the hub 20 includes a rotor 64 coupled to the fan blades 18 and a nose cone 66 that extends forward from the rotor 64. A portion of the particles in the airflow 13 may be directed radially outward by impinging on the hub 20 and conducted around the engine core 14. As a result, the hub 20 may help separate particles and provide the clean airflow 21 to the engine core 14.

The airflow duct assembly 16 is shaped to remove particles from the airflow 13 as suggested in FIGS. 2 and 3. The airflow duct assembly 16 is annular and extends circumferentially around the central axis 11 as shown in FIGS. 2 and 3. The airflow duct assembly 16 includes an inner wall 30, an outer wall 32, a by-pass flow splitter 34, and a particle separator splitter 29 as shown in FIGS. 2 and 3.

The hub 20, the inner wall 30, the by-pass flow splitter 34, and the particle separator splitter 29 cooperate to define the particle separator 28. The particle separator 28 is configured to impart inertial forces on the particles during operation of the gas turbine engine 10 to separate the airflow 13 into the dirty airflow 19 containing particles and the clean airflow 21 substantially free of particles before conducting the clean airflow 21 into the engine core 14. Illustratively, the particle separator 28 is annular and extends circumferentially around the central axis 11.

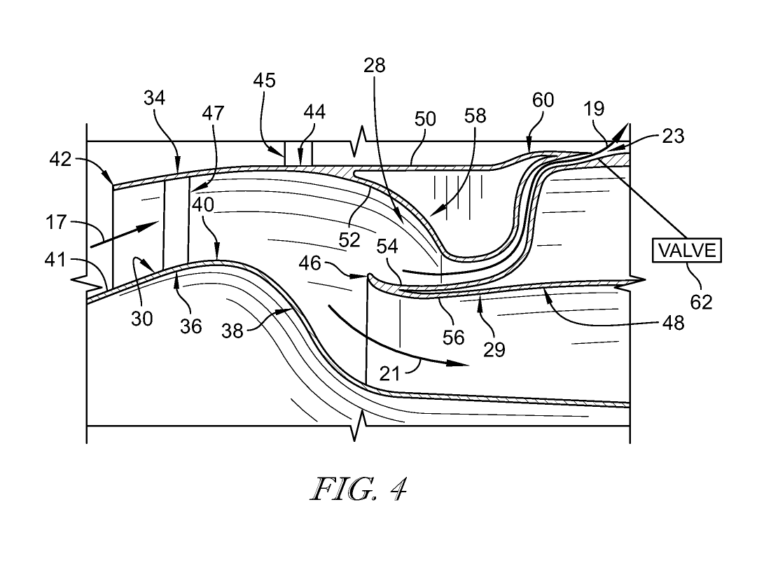

The inner wall 30 cooperates with the by-pass flow splitter 34 to define a core passageway 33 as shown in FIGS. 3 and 4. In the core passageway 33, the airflow 13 is directed radially inward toward the engine core 14 as the fan 12 pushes the airflow 13 into the gas turbine engine 10. The outer wall 32 is arranged circumferentially around the inner wall 30 and the fan 12 and cooperates with the by-pass flow splitter 34 to define the by-pass passageway 31 in which air is conducted around the engine core 14. The by-pass flow splitter 34 is arranged radially between the inner wall 30 and the outer wall 32 and is configured to separate the airflow 13 into a first portion conducted into the by-pass passageway 31 and into a second portion conducted into the core passageway 33.

The particle separator splitter 29 included in the airflow duct assembly 16 is arranged radially between the inner wall 30 and the by-pass flow splitter 34 to define a scavenge passageway 35 and an engine core passageway 37. The dirty airflow 19 laden with particles is directed into the scavenge passageway 35 and, illustratively, into the by-pass passageway 31. The clean airflow 21 without particles is directed into the engine core passageway 37 as suggested in FIG. 3.

The inner wall 30 of the airflow duct assembly 16 includes an axially forward portion 36 and an axially aft portion 38 as shown in FIGS. 3 and 4. The axially forward portion 36 of the inner wall 30 forms a radially outward extending peak 40. A maximum radius of the inner wall 30 measured from the central axis 11 to the inner wall 30 is defined by the radially outward extending peak 40.

In the illustrative embodiment, the hub 20 and axially forward portion 36 of the inner wall 30 define a continuous slope 41 extending radially outward away from central axis 11 as shown in FIGS. 3 and 4. In some embodiments, the continuous slope 41 is a constant slope. In other embodiments, the continuous slope 41 has a gradually increasing or decreasing positive slope. In the illustrative embodiment, the axially forward portion 36 of the inner wall 30 defines an angle α relative to the central axis. In some embodiments, the angle α is between about 20 and about 40 degrees. The airflow 13 is directed radially outward from the central axis 11 at the angle α by the hub 20 and the axially forward portion 36 of the inner wall 30.

The axially aft portion 38 of the inner wall 30 is shaped to extend radially inward from the radially outward extending peak 40 toward the central axis 11. The axially aft portion 38 interacts with the by-pass flow splitter body 44 to rapidly change the slope of the core passageway 33. Rapidly changing the slope of the core passageway 33 from the axially forward portion 36 to the axially aft portion 38 removes particles from the core airflow 17 using the inertia of the particles suspended in the airflow 13. In some embodiments, the axially aft portion 38 has a slope with an absolute value that is greater than the absolute value of the slope provided by the hub 20 and the axially forward portion 36 of the inner wall 30.

The outer wall 32 of the airflow duct assembly 16 is annular and extends circumferentially around the central axis 11 as suggested in FIG. 2. The outer wall 32 defines a space for the airflow 13 to flow into the gas turbine engine 10. A portion of the airflow 13 is defined as by-pass airflow 15 which is directed downstream to be used as thrust for the gas turbine engine 10. Another portion of the airflow 13 is defined as core airflow 17 which is directed toward the engine core 14 for combustion.

The by-pass flow splitter 34 includes a by-pass flow splitter tip 42 and a by-pass flow splitter body 44 as shown in FIG. 3. The by-pass flow splitter tip 42 is located axially forward toward the fan 12 and separates the airflow 13 into the by-pass airflow 15 and the core airflow 17. The by-pass flow splitter body 44 extends axially aft from the by-pass flow splitter tip 42.

The by-pass flow splitter body 44 cooperates with the particle separator splitter 29 to define the scavenge passageway 35 formed between the by-pass flow splitter body 44 and the particle separator splitter 29. The by-pass flow splitter body 44 includes a radially-outer surface 50 and a radially-inner surface 52 as shown in FIG. 3. The radially-outer surface 50 faces outward away from the central axis 11 toward the outer wall 32 and defines a portion of the by-pass passageway 31. The radially-inner surface 52 faces toward the inner wall 30 and the particle separator splitter 29 and defines a portion of the core passageway 33 and the scavenge passageway 35.

In the illustrative embodiment, the by-pass flow splitter tip 42 is positioned axially forward and radially outward of the radially outward extending peak 40 to split the airflow 13 into the by-pass airflow 15 and the core airflow 17. In some embodiments, the by-pass flow splitter tip 42 is actuated axially forward and aft to adjust the amount of airflow 13 delivered to the by-pass passageway 31 and the core passageway 33. The by-pass airflow 15 is conducted through the by-pass passageway 31 around the engine core 14 to provide thrust for the gas turbine engine 10 as suggested in FIG. 3. The core airflow 17 is conducted into the core passageway 33 where it is separated into the dirty airflow 19 and the clean airflow 21.

The particle separator splitter 29 includes a particle separator tip 46 and a particle separator body 48 as shown in FIGS. 3 and 4. The particle separator tip 46 helps separate the core airflow 17 into the dirty airflow 19 and the clean airflow 21. The particle separator body 48 extends axially aft from the particle separator tip 46 toward the engine core 14.

Illustratively, the particle separator tip 46 is located axially aft of the radially outwardly extending peak 40 of the inner wall 30 and radially inward of the by-pass flow splitter 34. The particle separator tip 46 is located radially inward of the radially outwardly extending peak 40.

The particle separator body 48 cooperates with the by-pass flow splitter body 44 to define the scavenge passageway 35 formed between the by-pass flow splitter 34 and the particle separator splitter 29. The particle separator body 48 includes a radially-outer surface 54 and a radially-inner surface 56 as shown in FIG. 3. The radially-outer surface 54 faces outward away from central axis A toward by-pass flow splitter 34 and defines a portion of the scavenge passageway 35. The radially-inner surface 52 faces toward the inner wall 30 and defines a portion of the core passageway 33.

The particle separator 28 is integrated within the airflow duct assembly 16 to separate the core airflow 17 into the dirty airflow 19 and the clean airflow 21 such that the clean airflow 21 is substantially free of particles. The dirty airflow 19, containing dirt, sand, or other particles, flows through the scavenge passageway 35 and is removed from the airflow duct assembly 16 as suggested in FIGS. 3 and 4. The clean airflow 21, substantially free from dirt, sand, or other particles, flows through the engine core passageway 37 into the engine core 14.

The airflow 13, which contains dirt, sand, or other particles, is directed radially outward by the hub 20 and the axially forward portion 36 of the inner wall 30. As the fan blades 18 rotate about the central axis 11, a radial force may be imparted on the particles causing some of the particles to flow radially outward from the central axis 11 and into the by-pass passageway 31. However, some of the particles may remain entrained in the core airflow 17 as the core airflow 17 is directed toward the engine core 14.

The core airflow 17, containing particles, is directed toward a lobed portion 58 of the by-pass flow splitter body 44 by the hub 20 and the axially forward portion 36 of inner wall 30. The particles, having a greater inertia than the surrounding air, continue on the trajectory provided by the hub 20 and the axially forward portion 36 of the inner wall 30. As such, the particles are guided by the lobed portion 58 and subsequently flow through the scavenge passageway 35 with the dirty airflow 19. The clean airflow 21 flows radially inward through the engine core passageway 37 and is delivered to the engine core 14 substantially without particles. The scavenge passageway 35 directs the particles from the core passageway 33 to the by-pass passageway 31 through a scavenge aperture 23 as shown in FIG. 3.

The by-pass flow splitter 34 further includes a by-pass area reducing feature 60 formed axially forward of the scavenge aperture 23. The by-pass area reducing feature 60 is configured to reduce the area of the by-pass passageway 31 directly upstream of the scavenge aperture 23 to cause a Venturi effect and urge the dirty airflow 19 out of the scavenge passageway 35 into the by-pass passageway 31. The Venturi effect aids in conducting the dirty airflow 19, including any particles entrained therein, from the scavenge passageway 35 into the by-pass passageway 31.

Illustratively, the by-pass area reducing feature 60 is an annular protrusion formed on the by-pass flow splitter 34 and extends radially outward from the central axis 11. In other embodiments, the by-pass area reducing feature 60 includes a stator vane, a bump, or another type of projection that reduces the area of the by-pass passageway 31 directly upstream of the scavenge aperture 23. In some embodiments, the by-pass area reducing feature 60 is formed on the outer wall 32 to extend radially inward from the outer wall 32.

In illustrative embodiments, the airflow duct assembly 16 includes a valve 62 positioned adjacent the scavenge aperture 23 as shown in FIG. 4. The valve 62 is configured to open and close the scavenge aperture 23 to allow or disallow flow through the scavenge passageway 35 and into the by-pass passageway 31.

The valve 62 is configured to open and close the scavenge aperture 23 depending on flight conditions. For example, the valve 62 may open the scavenge aperture 23 to remove particles entrained in the airflow 13 at low altitudes during take-off and landing. However, the valve 62 may be closed at higher altitudes due to the possible lack of particles entrained in the air. However, ice crystals, volcanic ash, or another type of particle may be present at high altitudes. Additionally, the valve 62 may be opened and closed only partially to control the amount of airflow passing through the scavenge passageway 35 in response to various operating conditions. Other operating conditions may include fan speed and aircraft speed.

Illustratively, the valve 62 is annular and extends circumferentially around central axis 11. The valve 62 may include a rotating ring that is opened and closed by being actuated so that the valve 62 extends and contracts as the valve 62 is rotated. In other embodiments, the valve 62 slidingly opens and closes the scavenge aperture 23.

In the illustrative embodiments, the airflow duct assembly 16 further includes stator vanes 45, 47 as shown in FIGS. 2 and 3. The stator vanes 45 extend between the outer wall 32 and the by-pass flow splitter 34. The stator vanes 47 extend between the inner wall 30 and the by-pass flow splitter 34. The stator vanes 45, 47 may include multiple sets of vanes positioned in different locations. The stator vanes 45, 47 may be positioned anywhere along the inner wall 30 and the outer wall 32.

Some embodiments of the present disclosure are directed toward turbofan engine applications such as fixed wing and variable wing aircraft frequently taking off and landing on an unimproved (unpaved) runway or conditions such and environmentally dirty atmospheric conditions affected by dust and/or ash pollution. Under these types of conditions, particulates such as dirt, sand, and/or ash may be ingested by the engine.

Typical inertial particle separator designs may not fit in the duct between the fan and the compressor. The present disclosure incorporates the fan as part of the inertial particle separator (IPS) system allowing the inner flow path of the IPS to extend ahead of the fan and provide an adequate axial length for the inner flow path of the IPS.

In some embodiments, the incorporation of the inertial particle separator may require an additional splitter for scavenge flow to be incorporated into the bypass splitter. The hub surface of the IPS may be part of the fan hub. The outer flow path of the IPS may be part of the bypass splitter inner surface.

In some embodiments, the hub surface of the IPS are extended upstream through the fan. The upstream portion of the hub surface may cause larger particles to bounce off the surface and then bounce off the outer surface into the scavenge duct. The fan may impart centrifugal force on the particles and swirl. The centrifugal force may move particles toward the bypass duct. The swirl may extend the time the particles remain upstream of the scavenge duct due to the tangential direction and some may also be captured into the scavenge duct.

In some embodiments, the extension of the hub surface into the fan allows the radial extension of the hub surface behind the fan to accelerate particulates and may create a region of higher inertia forces due to the rapid turning of the flow. The larger particles may depart the flow streamline directions and enter the scavenge duct. The scavenge flow may enter the bypass duct and exit downstream through the engine exhaust nozzle. The rest of the fan flow may enter the core and the compressor.

In some embodiments, there is an area reduction in the bypass duct near the scavenge exit that accelerates the bypass flow locally, reducing the static pressure and causing the scavenge flow to move into the bypass duct without the aid of blowers that may be typical in turboshaft applications. The integrated IPS may also form part of the typical fan by-pass air flow splitter to allow fan air to redistribute the air entering the fan into the core and engine by-pass flowpaths depending on the system flow requirements for the engine and fan duct exit nozzle area.

In some embodiments, there are two splitters for the bypass flow: an upstream splitter, which includes the outer surface of the particle separator, and the scavenge duct splitter. Flow from the fan may enter the bypass duct via either splitter. A valve may be incorporated at the scavenge duct exit to control the amount of flow that enters the bypass duct. This may be part of controlling the scavenge flow if an ejector system is used. In addition to capturing particulates, the scavenge flow control may be used for fan/engine operability by providing an additional control on core flow and bypass flow.

In some embodiments, the fan contributes to the removal of particles due to the tangential velocity it imparts on particles entering the fan. Particles may move to the outer radius and flow through the bypass duct. In some embodiments, a vane is placed behind the fan and may be used to reduce the amount of swirl entering the separator. This may reduce the velocity somewhat within the separator, but still maintain the benefits of some swirl to help remove particles from the core flow.

In some embodiments, the length of the particle separator outer surface may vary from being very near the fan to zero length. At zero length, particles may exit directly into the bypass duct. The scavenge duct may act as the flow splitter for the bypass duct. Other variants of the present disclosure include multiple scavenge ducts, multi-stage fan, variable geometry of the IPS, fan and bypass components. The particle separator may be used to separate ash, dirt, ice, salt and other particulates from airflows.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A gas turbine engine comprising
a fan mounted for rotation about a central axis of the gas turbine engine,
an engine core coupled to the fan and configured to drive the fan about the central axis to cause the fan to push a mixture of air and particles suspended in the air to provide thrust for the gas turbine engine, and
an airflow duct assembly configured to conduct the mixture of air and particles through the gas turbine engine, the airflow duct assembly defining a core passageway configured to conduct a first portion of the mixture of air and particles pushed by the fan into the engine core and a by-pass passageway configured to conduct a second portion of the mixture of air and particles pushed by the fan around the engine core, and
wherein the airflow duct assembly includes a particle-separator splitter positioned in the core passageway and configured to separate the first portion of the mixture of air and particles into a clean flow substantially free of particles and a dirty flow containing the particles and the particle-separator splitter is arranged to direct the clean flow into the engine core and the dirty flow away from the engine core.

2. The gas turbine engine of claim 1, wherein the airflow duct assembly further includes an inner wall arranged circumferentially around the central axis, an outer wall arranged circumferentially around the inner wall and the fan, and a by-pass flow splitter located radially between the inner wall and the outer wall, the inner wall and the by-pass flow splitter define the core passageway, the outer wall and the by-pass flow splitter define the by-pass passageway, and a tip of the particle-separator splitter is located downstream of a tip of the by-pass flow splitter.

3. The gas turbine engine of claim 2, wherein the inner wall of the airflow duct assembly includes a forward portion and an aft portion located axially aft of the forward portion, the forward portion forms a radially outward extending peak having a maximum radius, the aft portion is located radially inward of the maximum radius of the peak of the forward portion, and the particle-separator splitter is located radially inward of the maximum radius of the peak of the forward portion.

4. The gas turbine engine of claim 2, wherein the particle-separator splitter and the by-pass flow splitter define a scavenge passageway having an inlet that opens into the core passageway and an outlet that opens into the by-pass passageway, one of the inner wall and the outer wall includes a protrusion that extends radially into the by-pass passageway to reduce an area of the by-pass passageway, and the protrusion is located adjacent the outlet of the scavenge passageway.

5. The gas turbine engine of claim 2, wherein the particle-separator splitter and the by-pass flow splitter define a scavenge passageway having an inlet that opens into the core passageway and an outlet that opens into the by-pass passageway, the airflow duct assembly includes a vane that extends between the by-pass flow splitter and the outer wall, and the vane is located adjacent the outlet of the scavenge passageway.

6. The gas turbine engine of claim 1, wherein the airflow duct assembly further includes a by-pass flow splitter configured to separate radially the by-pass passageway and the core passageway, the particle-separator splitter and the by-pass flow splitter define a scavenge passageway in fluid communication with the core passageway and the by-pass passageway, and the scavenge passageway is arranged to conduct the dirty flow from the core passageway into the by-pass passageway.

7. The gas turbine engine of claim 6, further comprising a valve configured to move between an open position in which fluid flow through the scavenge passageway is allowed and a closed position in which fluid flow through the scavenge passageway is blocked.

8. The gas turbine engine of claim 1, wherein the airflow duct assembly includes an inner wall arranged circumferentially around the central axis, an outer wall arranged circumferentially around the inner wall and the fan, and a by-pass flow splitter located radially between the inner wall and the outer wall, the inner wall includes a forward portion and an aft portion located axially aft of the forward portion, the forward portion extends radially outward away from the central axis and cooperates with the central axis to define an angle alpha, and the angle alpha is in a range of about 20 degrees to about 40 degrees.

9. A gas turbine engine comprising
a fan mounted for rotation about a central axis of the gas turbine engine,
an engine core coupled to the fan and configured to drive the fan about the central axis to cause the fan to push a mixture of air and particles suspended in the air to provide thrust for the gas turbine engine, and
an airflow duct assembly including an inner wall arranged circumferentially around the central axis, an outer wall arranged circumferentially around the inner wall and the fan, a by-pass flow splitter located radially between the inner wall and the outer wall to form a core passageway and a by-pass passageway arranged around the core passageway, and a particle-separator splitter positioned in the core passageway.

10. The gas turbine engine of claim 9, wherein the inner wall of the airflow duct assembly includes a forward portion and an aft portion located axially aft of the forward portion, the forward portion forms a radially outward extending peak having a maximum radius, the aft portion is located radially inward of the maximum radius of the peak of the forward portion, and the particle-separator splitter is positioned radially inward of the maximum radius of the peak of the forward portion.

11. The gas turbine engine of claim 9, wherein the inner wall includes a forward portion and an aft portion located axially aft of the forward portion, the forward portion extends radially outward away from the central axis and cooperates with the central axis to define an angle alpha, and the angle alpha is in a range of about 20 degrees to about 40 degrees.

12. The gas turbine engine of claim 9, wherein the particle-separator splitter and the by-pass flow splitter define a scavenge passageway in fluid communication with the core passageway and the by-pass passageway.

13. The gas turbine engine of claim 12, further comprising a valve configured to move between an open position in which fluid flow through the scavenge passageway is allowed and a closed position in which fluid flow through the scavenge passageway is blocked.

14. The gas turbine engine of claim 9, wherein a tip of the particle-separator splitter is located downstream of a tip of the by-pass flow splitter.

15. The gas turbine engine of claim 9, wherein the particle-separator splitter and the by-pass flow splitter define a scavenge passageway having an inlet that opens into the core passageway and an outlet that opens into the by-pass passageway, one of the inner wall and the outer wall includes a protrusion that extends radially into the by-pass passageway, and the protrusion is located adjacent and upstream of the outlet of the scavenge passageway.

16. The gas turbine engine of claim 10, wherein the particle-separator splitter and the by-pass flow splitter define a scavenge passageway having an inlet that opens into the core passageway and an outlet that opens into the by-pass passageway, the airflow duct assembly includes a vane that extends between the by-pass flow splitter and the outer wall, and the vane is located adjacent and upstream of the outlet of the scavenge passageway.

17. A method comprising
providing a gas turbine engine having a fan, an engine core coupled to the fan, and a duct assembly arranged around the fan and the engine core, the duct assembly defining a core passageway in fluid communication with the engine core and a by-pass passageway arranged circumferentially around the core passageway,
directing a flow of air and particles suspended in the air downstream with the fan,
conducting a first portion of the flow of air and particles radially inward into the core passageway,
conducting a second portion of the flow of air and particles into the by-pass passageway, and
separating the first portion of the flow of air and particles into a dirty flow including substantially all the particles and a clean flow lacking substantially all the particles,
directing the dirty flow through a scavenge passageway into the by-pass passageway, and
directing the clean flow to a compressor included in the engine core.

18. The method of claim 17, further comprising reducing a cross-sectional area of the by-pass passageway adjacent an outlet of the scavenge passageway.

19. The method of claim 17, wherein the duct assembly further includes a valve and the method further includes varying a flow rate through the scavenge passageway with the valve.

20. The method of claim 19, further comprising varying the flow rate with the valve based on operating conditions of the gas turbine engine and wherein the operating conditions include at least one of fan speed and an altitude of the gas turbine engine.
